(19) United States
(12) Patent Application Publication
(10) Pub. No.: US 2011/0180220 A1
(43) Pub. Date: Jul. 28, 2011

(54) SHUTTER LATTICE

(75) Inventor: Tsung-Hsiung TSAI, Jhushan Township (TW)

(73) Assignee: HSIN HUAN Co., Ltd., Jhushan Township (TW)

(21) Appl. No.: 12/692,784

(22) Filed: Jan. 25, 2010

(51) Int. Cl. E06B 9/302

(52) U.S. Cl. 160/168.1 R

(57) ABSTRACT

A lattice with lifting ring has a front strip and a rear strip arranged at interval, which are extended to define a top and a bottom. Multiple blade sustaining portions are linked between the front and rear strips at interval. A connecting and positioning portion is integrally formed on top of the front and rear strips. The connecting and positioning portion of a straight pattern eliminates the problem of cutting off several blade sustaining portions. A pair of lifting rings are integrally formed on the end of said connecting and positioning portion at top of the front and rear strips. A threading portion is formed on said lifting ring for positioning onto a preset retaining location of the existing shutter's rotary braking seat. When the lattice is assembled onto the rotary braking seat, the lifting rings can be used for sleeving onto the retaining location of the rotary braking seat.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a lattice of a shutter, and more particularly to an innovative one which allows a lifting ring to be formed onto one end of its connecting and positioning portion. lines to be set on the inner wall of the heat-insulating tube and mated closely with the cup body.

2. Description of Related Art Including Information Disclosed Under 37 CFR 1.97 and 37 CFR 1.98.

A lattice (or a ratline) is a component of a shutter that enables transversal positioning and simultaneous swinging of the shutter's blades.

Said lattice is of either a sheet or a rope pattern, and generally composed of front and rear strips as well as a blade sustaining portion connected between front and rear strips. Firstly, a rolled substrate is fabricated, and then tailored into unit strips ofpreset length for processing into the shutter, depending on the intended number of shutter's blades.

To cut the lattice into unit strips, some influential factors to the accuracy and quality of assembled blade shall be considered. At the top of the stripped lattice, a connecting and positioning portion must be reserved; the connecting and positioning portion is used for threading into a rotary braking seat preset in the shutter lever. Then, the connecting and positioning portion is positioned securely via a snapper. Any error of the connecting point of the snapper will lead to poor assembly accuracy of the blades due to inconsistent positioning points.

However, it is observed from actual application of the conventional lattice that, the connecting and positioning portion and the rotary braking seat are assembled and positioned by troublesome threading and snapping behaviors. Moreover, the threading and snapping of said connecting and positioning portion will probably lead to higher assembly deviation and failure, which requires further improvement.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

Based on the unique configuration of the “lattice with a lifting ring” wherein two lifting rings are integrally formed on the end of said connecting and positioning portion 26 at top of the front and rear strips, when said lattice is to be assembled onto the rotary braking seat of the shutter, the lifting rings can be used for sleeving onto the retaining location of the rotary braking seat without other locating members (e.g. metal clip). This allows to simplify the structure and facilitate the assembly with improved applicability and industrial benefits.

Furthermore, with the setting of said lifting ring, a clear identification point is provided for tailoring and feeding of the lattice, thus reducing the error of feeding and assembly, and improving the working efficiency, accuracy and performance as well as facilitating the quality inspection with better applicability and industrial benefits.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a schematic view of preferred embodiment of the lattice of the present invention.

FIG. 2 shows a perspective view of the assembled shutter of the present invention.

FIG. 3 shows a perspective view of the partially structured shutter of the present invention.

FIG. 4 shows schematic views (a) through (d) of the operating steps of the present invention.

FIG. 5 shows a schematic view of a preferred embodiment of the present invention wherein the lattice is provided with a pull rope's threading ring.

FIG. 6 shows a perspective view of a preferred embodiment of rolled lattice of the present invention.

FIG. 7 shows a perspective view of the present invention wherein the lattice is of a twisted overlapped pattern.

### DETAILED DESCRIPTION OF THE INVENTION

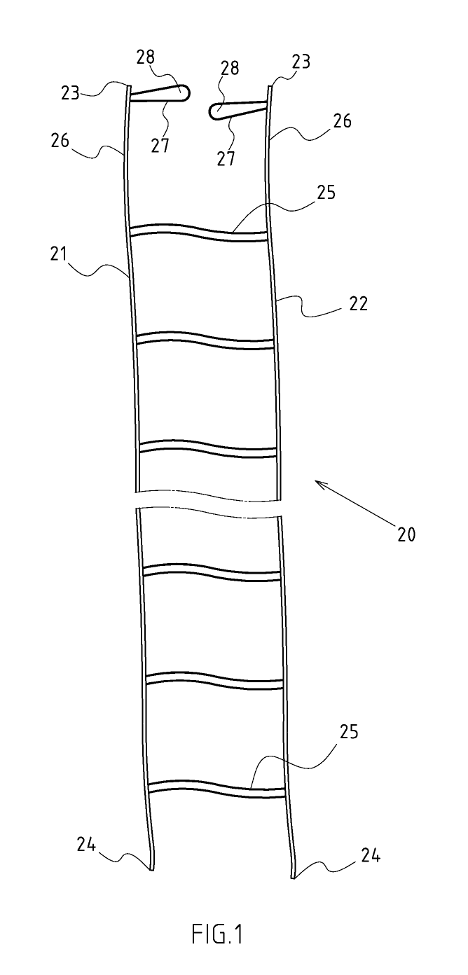

FIGS. 1-3 depict preferred embodiments of a lattice of the present invention with a lifting ring, which are provided for only explanatory objective for patent claims. The lattice 20 is used for assembly onto the shutter in a predefined strip pattern. The lattice 20 includes a front strip 21 and a rear strip 22, both of which are arranged at interval. The front and rear strips 21, 22 are extended to define a top 23 and a bottom 24.

Multiple blade sustaining portions 25 are linked between the front and rear strips 21, 22 at interval.

A connecting and positioning portion 26 is integrally formed on the top 23 of the front and rear strips 21, 22. The connecting and positioning portion 26 of a straight pattern eliminates the problem of cutting off several blade sustaining portions 25.

Two lifting rings 27 are integrally formed on the end of said connecting and positioning portion 26 at top of the front and rear strips 21, 22. A threading portion 28 is formed on the lifting ring 27 for positioning onto a preset retaining location of existing shutter's rotary braking seat, enabling direct assembly and positioning of the lattice 20. Moreover, said lifting ring 27 is provided with an accurate identification point for tailoring and feeding of lattice 20.

Of which, the front and rear strips 21, 22 as well as the blade sustaining portion 25 are of rope or sheet patterns.

Of which, the lifting ring 27 can be woven directly into loop patterns by the weaving threads of the front and rear strips 21, 22.

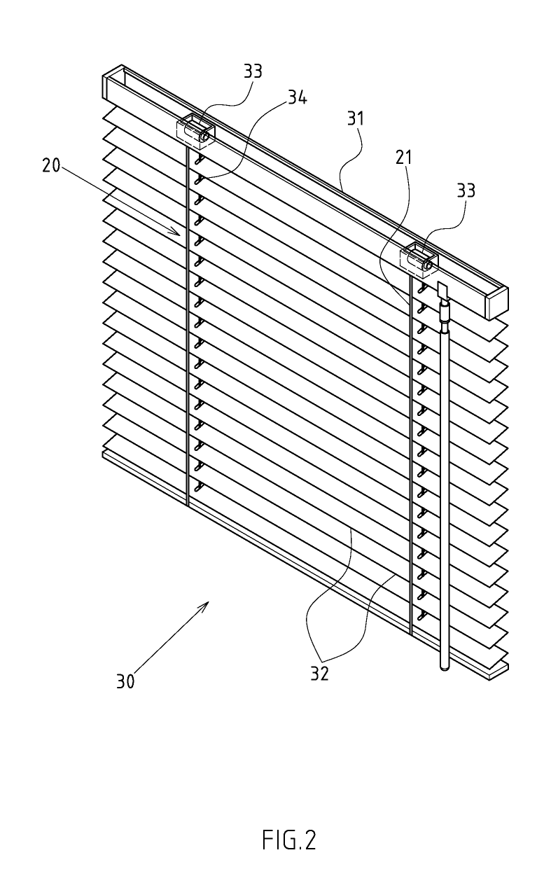

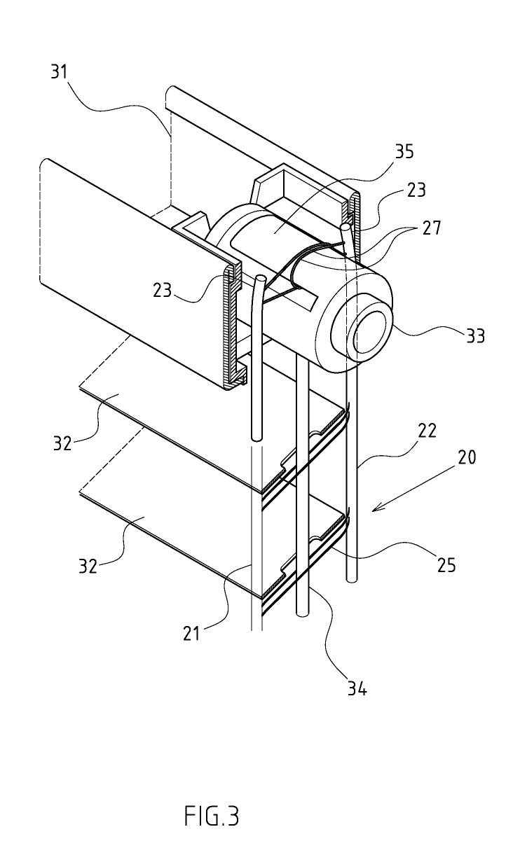

Referring to FIGS. 2 and 3, preferred embodiments of said lattice 20 that's assembled onto a shutter 30, wherein the shutter 30 comprises a lever 31, multiple blades 32, at least two rotary braking seats 33 and a pull rope 34. The rotary braking seat 33 includes a retaining location 35. Said lattice 20 is sleeved directly onto the retaining location 35 through the lifting ring 27 at top 23 of the connecting and positioning portion 26, helping to position securely the connecting and positioning portion 26 and the lattice 20 as a whole.

Said retaining location 35 is available with multiple patterns. Referring to FIG. 3, said retaining location 35 is designed into a flat pole transversely arranged, allowing for sleeving of two lifting rings 27 of the lattice 20 in opposite direction. Besides, said retaining location is designed into two sleeving columns or hooks arranged at interval, so that two lifting rings 27 of the lattice 20 can be sleeved individually or in a cross pattern.

Based on above-specified structural configuration, the present invention is operated as follows:

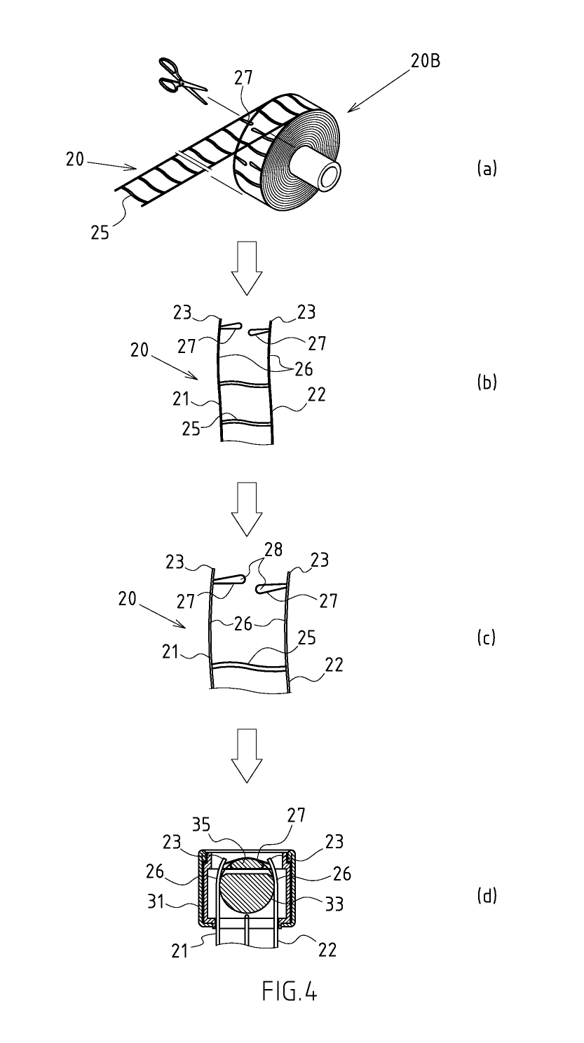

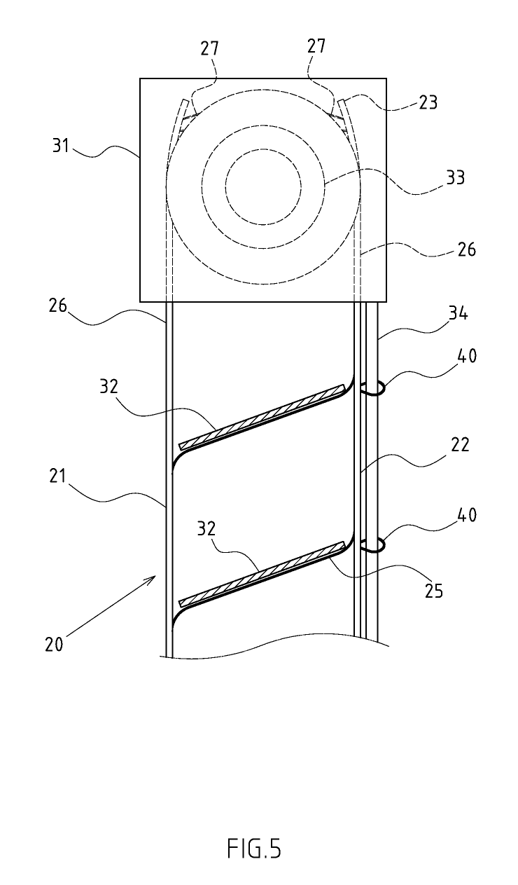

Referring to FIG. 4(a), firstly, the assembly personnel must pull the substrate of rolled lattice 20B to the lifting ring 27 for tailoring. Referring also to FIG. 4 (b), it can be tailored into strips of lattice 20. Referring also to FIGS. 4 (c),(d), the lifting ring 27 formed on top 23 of the connecting and positioning portion 26 of the lattice 20 is sleeved directly onto the retaining location 35 of the rotary braking seat 33 in the shutter lever 30, helping to position securely the connecting and positioning portion 26 and the lattice 20 as a whole. So the lattice 20 and the rotary braking seat 33 are assembled to enable vertical and secure application of the lattice 20 (in conjunction with FIG. 5).

Referring to FIG. 5, a pull rope's threading ring 40 is formed on the exterior of the rear strip 22 (or front strip 21) of the lattice 20, such that the pull rope 34 of the shutter 30 can be threaded securely.

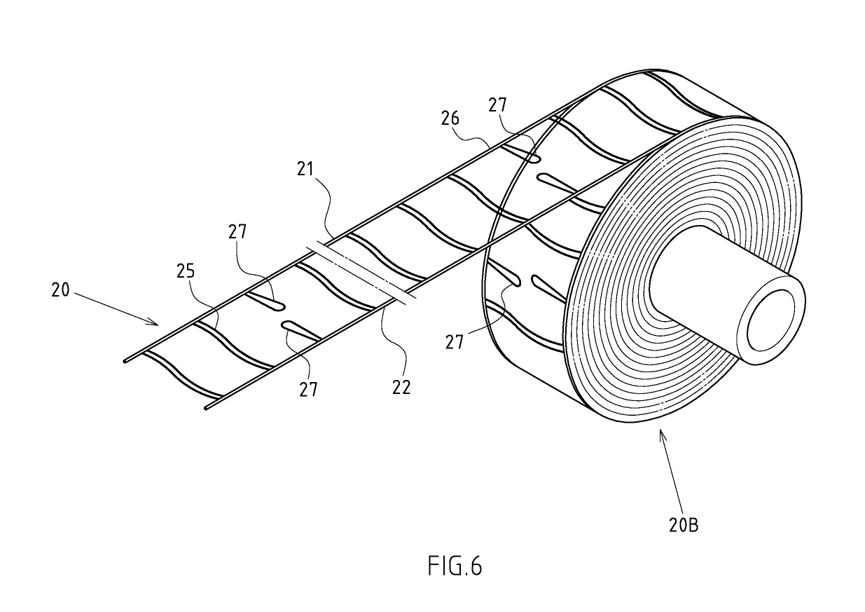

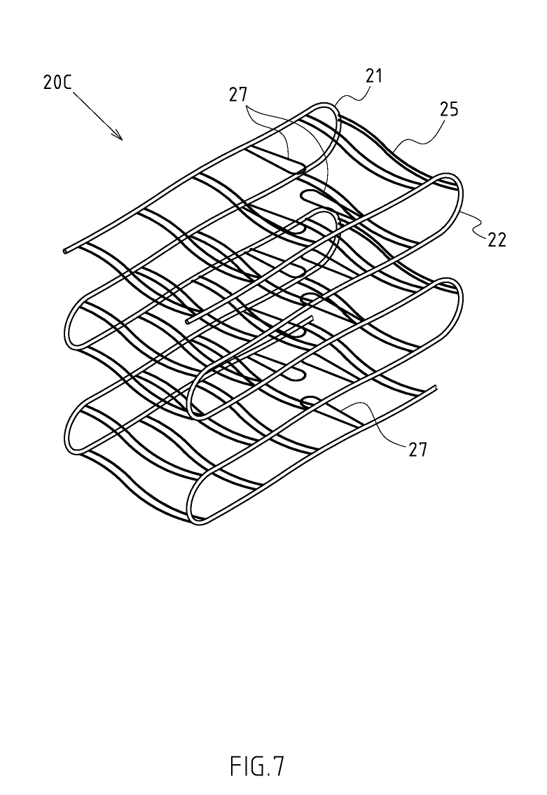

Referring also to FIG. 6, said lattice 20B is also of an integrally rolled substrate pattern. Or, referring to FIG. 7, said lattice 20C is of a twisted overlapped pattern.

1. A lattice with lifting ring in a predefined strip pattern, comprising:
a front strip and a rear strip, both of which are arranged at interval wherein the front and rear strips are extended to define a top and a bottom;
multiple blade sustaining portions linked between the front and rear strips at interval;
a connecting and positioning portion integrally formed on the top of the front and rear strips, wherein the connecting and positioning portion of a straight pattern eliminates the problem of cutting off several blade sustaining portions;
two lifting rings integrally formed on the end of said connecting and positioning portion at top of the front and rear strips; a threading portion is formed on said lifting ring for positioning onto a preset retaining location of existing shutter's rotary braking seat.

2. The structure defined in claim 1, wherein the front and rear strips and the blade sustaining portion are of rope or sheet patterns.

3. The structure defined in claim 1, wherein the lifting ring can be woven directly into loop patterns by the weaving threads of the front and rear strips.

4. The structure defined in claim 1, wherein a pull rope's threading ring is formed on the exterior of the rear strip or front strip of the lattice.

5. The structure defined in claim 1, wherein said lattice is of an integrally rolled substrate pattern or a twisted overlapped pattern.

6. The structure defined in claim 1, wherein said lattice is assembled onto a shutter; the shutter comprises a lever, multiple blades, rotary braking seats and a pull rope; of which the rotary braking seat includes a retaining location; so the lifting rings can be used for sleeving onto the retaining location of the rotary braking seat, helping to position securely the connecting and positioning portion and the lattice as a whole.

7. The structure defined in claim 6, wherein said retaining location is designed into a flat pole transversely arranged, allowing for sleeving of two lifting rings of the lattice in opposite direction.

8. The structure defined in claim 6, wherein said retaining location is configured with two sleeving columns or hooks arranged at interval, so that two lifting rings of the lattice can be sleeved individually or in a cross pattern.
